(19) United States
(12) Patent Application Publication
(10) Pub. No.: US 2014/0341326 A1
(43) Pub. Date: Nov. 20, 2014

(54) CHANNEL ESTIMATION WITH DISCONTINUOUS PILOT SIGNALS

(71) Applicant: QUALCOMM Incorporated, San Diego, CA (US)

(72) Inventors: Jun Won Choi, Seoul (KR); Won-Joon Choi, San Diego, CA (US)

(73) Assignee: QUALCOMM Incorporated, San Diego, CA (US)

(21) Appl. No.: 14/280,348

(22) Filed: May 16, 2014

Related U.S. Application Data
(60) Provisional application No. 61/825,446, filed on May 20, 2013.

(51) Int. Cl. H04L 25/02

(52) U.S. Cl. CPC H04L 25/0214
USPC 375/350

(57) ABSTRACT

Methods, systems, and apparatuses to estimate a channel with discontinuous instances of a pilot signal. A pilot signal is received during a first and second time period. The time periods are separated by a blank period. The pilot signal is not received during the blank period. A pilot signal received during the second time period is combined with a pilot signal received during the first time period. A channel estimate is based on the combination. According to a second method, pilot signals are received. A first and second channel estimate is calculated based on the pilot signals. Data symbols are received following the pilot signals. A third channel estimate is extrapolated from the channel estimates. This channel estimate corresponds to a virtualized instance of the pilot signal. The data symbols are interpolated based on the second and third channel estimates.

### CROSS REFERENCES

The present application for patent claims priority to U.S. Provisional Patent Application No. 61/825,446 by Choi et al., entitled “Channel Estimation with Discontinuous Pilot Signals,” filed May 20, 2013, assigned to the assignee hereof, and expressly incorporated by reference herein.

### BACKGROUND

The following relates generally to wireless communications, and more specifically to channel estimation in wireless communications. Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communication system may include a number of base stations, each simultaneously supporting communication for multiple mobile devices. Base stations may communicate with mobile devices using downstream and upstream links Base stations may also communicate with mobile devices using frequency-division duplex (FDD) schemes and time-division duplex (TDD) schemes, using a discontinuous reception (DRX) scheme, and using other schemes. Channel estimation may typically be performed based on an assumption that instances of a pilot signal are being continuously received by a mobile device. When, for example, instances of a pilot signal are received discontinuously, or when one or more data symbols follow a last received instance of a pilot signal in a particular transmission, the accuracy of channel estimation may degrade.

### SUMMARY

The described features generally relate to one or more improved methods, systems, and/or apparatuses for estimating a channel.

In one configuration, a method for estimating a channel with discontinuous instances of a pilot signal is described. At least one instance of a pilot signal may be received during a first time period. At least one instance of the pilot signal may be received during a second time period that is subsequent to the first time period. The second time period may be separated from the first time period by a blank period. Instances of the pilot signal may not be received during the blank period. A first instance of the pilot signal received during the second time period may be combined with an instance of the pilot signal received during the first time period. A channel estimate may be based at least in part on the combination.

In some embodiments, calculating the channel estimate may include calculating a coefficient corresponding to the first instance of the pilot signal received during the second time period.

In some embodiments, a Doppler frequency of a channel over which the instances of the pilot signal are received may be identified; a signal to noise ratio (SNR) of the channel may be identified; and a length of the blank period may be identified. The length of the blank period may be identified based at least in part on a number of unreceived instances of the pilot signal during the blank period. The coefficient may be a function of at least the Doppler frequency, the SNR, and the length of the blank period.

In some embodiments, a second instance of the pilot signal received during the second time period may be combined with the first instance of the pilot signal received during the second time period. Also, a coefficient corresponding to the second instance of the pilot signal received during the second time period may be calculated. The coefficient may be less than a coefficient corresponding to the first instance of the pilot signal received during the second time period.

In some embodiments, a coefficient corresponding to each instance of the pilot signal received during the second time period may be calculated. A channel estimate may then be calculated based at least in part on each coefficient. In some cases, the coefficient for each subsequent instance of the pilot signal may decay with respect to a previous coefficient, until a steady-state coefficient is reached.

In some examples, the blank period may be caused by a time-division duplex (TDD) scheme. In other examples, the blank period may be caused by a discontinuous reception (DRX) scheme. In still other examples, the blank period may be caused by a Multimedia Broadcast Single-Frequency Network (MBSFN) signal reception. In additional examples, the blank period may be caused by a measurement gap.

In another configuration, an apparatus for estimating a channel with discontinuous instances of a pilot signal is described. The apparatus may include a processor, memory in electronic communication with the processor, and instructions stored in the memory. The instructions may be executable by the processor to receive at least one instance of a pilot signal during a first time period; receive at least one instance of the pilot signal during a second time period that is subsequent to the first time period; combine a first instance of the pilot signal received during the second time period with an instance of the pilot signal received during the first time period; and calculate a channel estimate based at least in part on the combination. The second time period may be separated from the first time period by a blank period, and instances of the pilot signal may not be received during the blank period.

In another configuration, a method for estimating a channel in which one or more data symbols follow an instance of a last pilot signal in a particular transmission is described. In accordance with this second method, at least a first instance of a pilot signal and a second instance of a pilot signal may be received. The second instance of the pilot signal may be the last instance of the pilot signal in the particular transmission, and the first instance of the pilot signal may temporally precede the second instance of the pilot signal. A first channel estimate may be calculated based at least in part on the first instance of the pilot signal and a second channel estimate may be calculated based at least in part on the second instance of the pilot signal. One or more data symbols may be received following the receipt of the second instance of the pilot signal. A third channel estimate may be extrapolated from the first and second channel estimates. The third channel estimate may correspond to a virtualized instance of the pilot signal following the second instance of the pilot signal. The one or more data symbols may be interpolated based at least upon the second channel estimate and the extrapolated third channel estimate.

In some embodiments, the first and second channel estimates may be based on a first filtered channel impulse response (CIR) and a second filtered CIR, respectively. In other embodiments, the first and second channel estimates are based on a first unfiltered CIR and a second unfiltered CIR, respectively.

In some embodiments, the first instance of the pilot signal and the second instance of the pilot signal may be received during a downlink (DL) transmission period of a subframe, and a timing of the virtualized instance of the pilot signal may be selected to be during a blank period following the second instance of the pilot signal.

In some embodiments, the first instance of the pilot signal and the second instance of the pilot signal may be received during a special subframe (SSF), and a timing of the virtualized instance of the pilot signal may be selected to be during a blank period of the special subframe.

In some embodiments, extrapolating the third channel estimate may include calculating an extrapolation coefficient, and applying the extrapolation coefficient to a linear combination of the first and second channel estimates. In some of these embodiments, the extrapolation coefficient may be a function of at least a Doppler frequency of the channel and a signal to noise ratio (SNR) of the channel. The extrapolation coefficient may be increased as the Doppler frequency increases, and decreased as the Doppler frequency decreases. The extrapolation coefficient may be decreased as the SNR decreases, and increased as the SNR increases.

In another configuration, an apparatus for estimating a channel in which one or more data symbols follow a last instance of a pilot signal in a particular transmission is described. The apparatus may include a processor, memory in electronic communication with the processor, and instructions stored in the memory. The instructions may be executable by the processor to: receive at least a first instance of a pilot signal and a second instance of a pilot signal, where the second instance of the pilot signal may be the last instance of the pilot signal in the particular transmission, and the first instance of the pilot signal may temporally precede the second instance of the pilot signal; calculate a first channel estimate based at least in part on the first instance of the pilot signal and calculate a second channel estimate based at least in part on the second instance of the pilot signal; receive one or more data symbols following the receipt of the second instance of the pilot signal; extrapolate a third channel estimate from the first and second channel estimates, the third channel estimate corresponding to a virtualized instance of the pilot signal following the second instance of the pilot signal; and interpolate the one or more data symbols based at least upon the second channel estimate and the extrapolated third channel estimate.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2 is a block diagram of a UE capable of estimating a channel in accordance with various embodiments;

FIG. 3 is a block diagram of a receiver module capable of estimating a channel in accordance with various embodiments;

FIG. 4 is a block diagram of another receiver module capable of estimating a channel in accordance with various embodiments;

FIG. 5 is a block diagram of a combination module used for channel estimation in accordance with various embodiments;

FIG. 6 is a block diagram illustrating an extrapolation module used for channel estimation in accordance with various embodiments;

FIG. 7 is a timing diagram showing an example of how a UE may estimate a channel in the presence of discontinuous instances of a pilot signal in accordance with various embodiments;

FIG. 8 is a timing diagram showing an example of how a UE may estimate a channel in which one or more data symbols follow a last instance of a pilot signal in a particular transmission in accordance with various embodiments;

FIG. 9 is a block diagram of a MIMO communication system in accordance with various embodiments;

FIG. 10 is a flow chart illustrating a method for estimating a channel with discontinuous instances of a pilot signal in accordance with various embodiments;

FIG. 11 is a flow chart illustrating another method for estimating a channel with discontinuous instances of a pilot signal in accordance with various embodiments;

FIG. 12 is a flow chart illustrating a method for estimating a channel in which one or more data symbols follow a last instance of a pilot signal in a particular transmission in accordance with various embodiments;

FIG. 13 is a flow chart illustrating another method for estimating a channel in which one or more data symbols follow a last instance of a pilot signal in a particular transmission in accordance with various embodiments;

FIG. 14 is a table illustrating a time division duplex (TDD) uplink downlink configuration in accordance with various embodiments;

FIG. 15 is a diagram illustrating an example TDD special subframe (SSF) configuration; and

FIG. 16 is a table illustrating example OFDM symbol allocations for different SSF configurations.

### DETAILED DESCRIPTION

Channel estimation in the presence of discontinuous instances of pilot signals, or in the presence of one or more data symbols that follow a last received instance of a pilot signal in a particular transmission, are described.

Channel estimation in orthogonal frequency-division multiplexing (OFDM) systems may typically be performed by filtering raw pilot symbols in time. A time domain or frequency domain raw channel impulse response (CIR) may be filtered by digital filters to average noise out from the pilot symbols. Channel estimation may be performed based on an assumption that instances of a pilot signal are being continuously received by a mobile device and its digital filter is in a steady-state. An infinite impulse response (IIR) filter having one or more coefficients may filter a channel impulse response estimate (CIRE) to obtain a sequence of output values (i.e., a filtered CIRE) The coefficients for the IIR filter may be selected so the IIR filter may best fit the overall conditions. For example, the IIR filter may be used for CIR filtering and an optimal filter coefficient can be derived based on steady-state performance metrics. When, for example, instances of a pilot signal are received discontinuously, or when one or more data symbols follow a last received instance of a pilot signal in a particular transmission, the accuracy of channel estimation derived for continuous pilot symbols may degrade. To reduce or prevent performance degradation, the IIR filter coefficients may be selected or optimized for certain parameters such as Doppler frequency, SNR, width of a blank period, and the like.

In some examples, other filters besides an IIR filter may be used. For example, a finite impulse response (FIR) filter having one or more FIR coefficients may be used for CIR filtering. For illustrative purposes only, the examples described herein use an IIR filter. However, it is to be understood that other suitable filters may be used in place of, or in addition to, an IIR filter.

Disclosed herein are methods, systems, and/or apparatuses that may provide improved channel estimation in particular contexts. For example, in the context of discontinuous instances of a pilot signal, instances of the pilot signal on either side of a blank period may be combined for the purpose of better estimating a channel. By way of further example, and in the context of one or more data symbols following a last received instance of a pilot signal in a particular transmission, a channel estimate for a virtualized instance of the pilot signal may be extrapolated from previous instances of the pilot signal, such that channel estimates are available on either side of the one or more data symbols.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

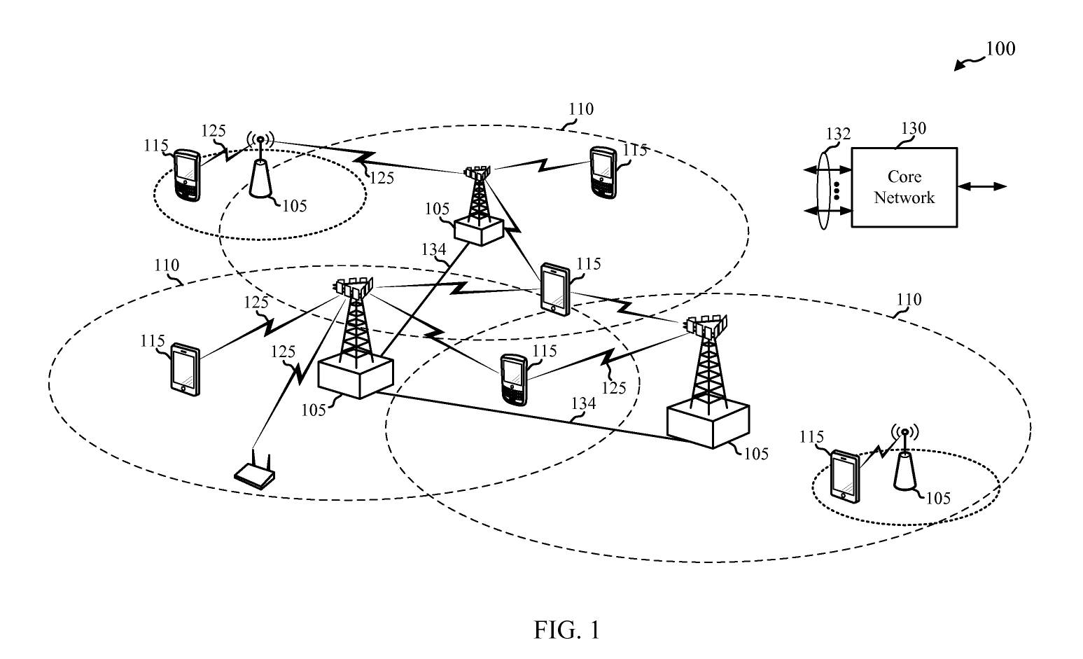

Referring first to FIG. 1, a diagram illustrates an example of a wireless communications system 100 (also referred to herein as the system 100). The system 100 includes base stations (or cells) 105, user equipments (UEs; e.g., mobile devices) 115, and a core network 130. The base stations 105 may communicate with the UEs 115 under the control of a base station controller, which may be part of the core network 130 or the base stations 105 in various embodiments. Base stations 105 may communicate control information and/or user data with the core network 130 through backhaul 132. In some embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to various radio technologies. Each modulated signal may be sent on a different carrier and may carry control information (e.g., reference signals, control channels, etc.), overhead information, data, or the like.

The base stations 105 may wirelessly communicate with the UEs 115 via one or more base station antennas. Each of the base stations 105 may provide communication coverage for a respective geographic coverage area 110. In some embodiments, a base station 105 may be referred to as a base transceiver station, a radio base station, an access point, a radio transceiver, a basic service set (BSS), an extended service set (ESS), a NodeB, an evolved Node B (eNB), a Home NodeB, a Home eNodeB, or some other suitable terminology. The geographic coverage area 110 for a base station 105 may be divided into sectors making up only a portion of the coverage area (not shown). The system 100 may include base stations 105 of different types (e.g., macro, micro, and/or pico base stations). There may be overlapping coverage areas for different technologies.

In some embodiments, the system 100 may be an LTE/LTE-A system (or network). In LTE/LTE-A systems, the term eNB may be generally used to describe the base stations 105. The system 100 may also be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access to UEs having an association with the femto cell (e.g., UEs in a closed subscriber group (CSG), UEs for users in the home, etc.). An eNB for a macro cell may be referred to as a macro eNB. An eNB for a pico cell may be referred to as a pico eNB. Similarly, an eNB for a femto cell may be referred to as a femto eNB or a home eNB. An eNB may support one or multiple (e.g., two, three, four, etc.) cells.

The core network 130 may communicate with the eNBs 105 via a backhaul 132 (e.g., 51, etc.). The eNBs 105 may also communicate with one another, e.g., directly or indirectly via backhaul links 134 (e.g., X2, etc.) and/or via backhaul 132 (e.g., through core network 130). The wireless communications system 100 may support synchronous or asynchronous operation. For synchronous operation, the eNBs 105 may have similar frame timing, and transmissions from different eNBs 105 may be approximately aligned in time. For asynchronous operation, the eNBs 105 may have different frame timing, and transmissions from different eNBs 105 may not be aligned in time. The techniques described herein may be used for either synchronous or asynchronous operations.

The UEs 115 may be dispersed throughout the system 100, and each UE 115 may be stationary or mobile. A UE 115 may be referred to by those skilled in the art as a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with macro eNBs, pico eNBs, femto eNBs, relays, and the like.

The communication links 125 shown in system 100 may include uplinks for carrying uplink (UL) transmissions (e.g., from a UE 115 to an eNB 105) and/or downlinks for carrying downlink (DL) transmission (e.g., from an eNB 105 to a UE 115). The DL transmissions may also be called forward link transmissions, while the UL transmissions may also be called reverse link transmissions.

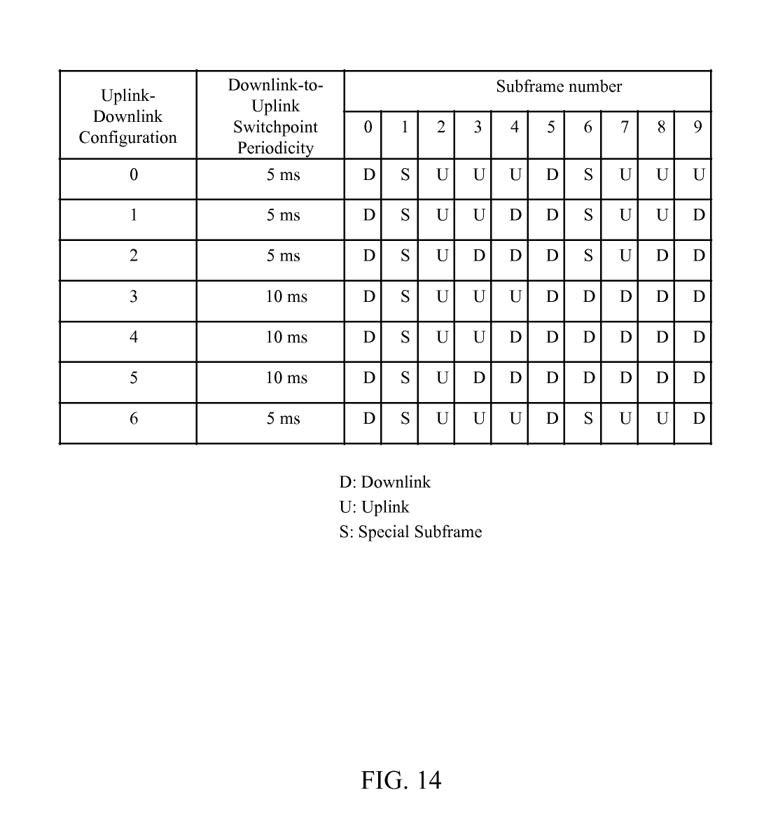

Communication over one or more of the communication links 125 (or one or more channels thereof) may be further configured in accord with a frequency division duplex (FDD) scheme or a time division duplex (TDD) scheme. In an FDD scheme, uplink transmissions are sent over a first frequency channel and downlink transmissions are sent over a second frequency channel. In a TDD scheme, uplink and downlink transmissions are time-division multiplexed over a single frequency channel. In a TDD scheme, downlink transmissions may therefore be discontinuous, leading to difficulties with channel estimation. In some embodiments, instances of a pilot signal occurring in respective first and second time periods of a TDD scheme (e.g., first and second DL subframes), which pilot signals are separated from each other by a blank period (e.g., a UL subframe), may be combined for purposes of improved channel estimation in the presence of discontinuous pilot signals. Different asymmetries in terms of the amount of resources (e.g., subframes) allocated for uplink and downlink transmission, respectively, are provided through seven different downlink/uplink configurations illustrated in FIG. 14.

Communication over one or more of the communication links 125 (or one or more channels thereof) may also be configured in accord with a discontinuous reception (DRX) scheme. In a DRX scheme, downlink transmissions may be received at discrete time periods, which time periods are separated by a blank period in which no downlink transmissions are received. In some embodiments, instances of a pilot signal occurring in respective first and second time periods (e.g., first and second DL subframes), which pilot signals are separated from each other by a blank period (e.g., a period in which no downlink transmissions are received), may be combined for purposes of improved channel estimation in the presence of discontinuous pilot signals.

Communication over one or more of the communication links 125 (or one or more channels thereof) may also be configured in accord with different subframe configurations. In some subframe configurations, instances of a pilot signal may be received during part but not all of the subframe. In these configurations, one or more data symbols may sometimes follow a last instance of a pilot signal received as part of a transmission. To improve channel estimation in these configurations, a channel estimate for a virtual instance of the pilot signal may be extrapolated from the channel estimates for instances of the pilot signal that were actually received.

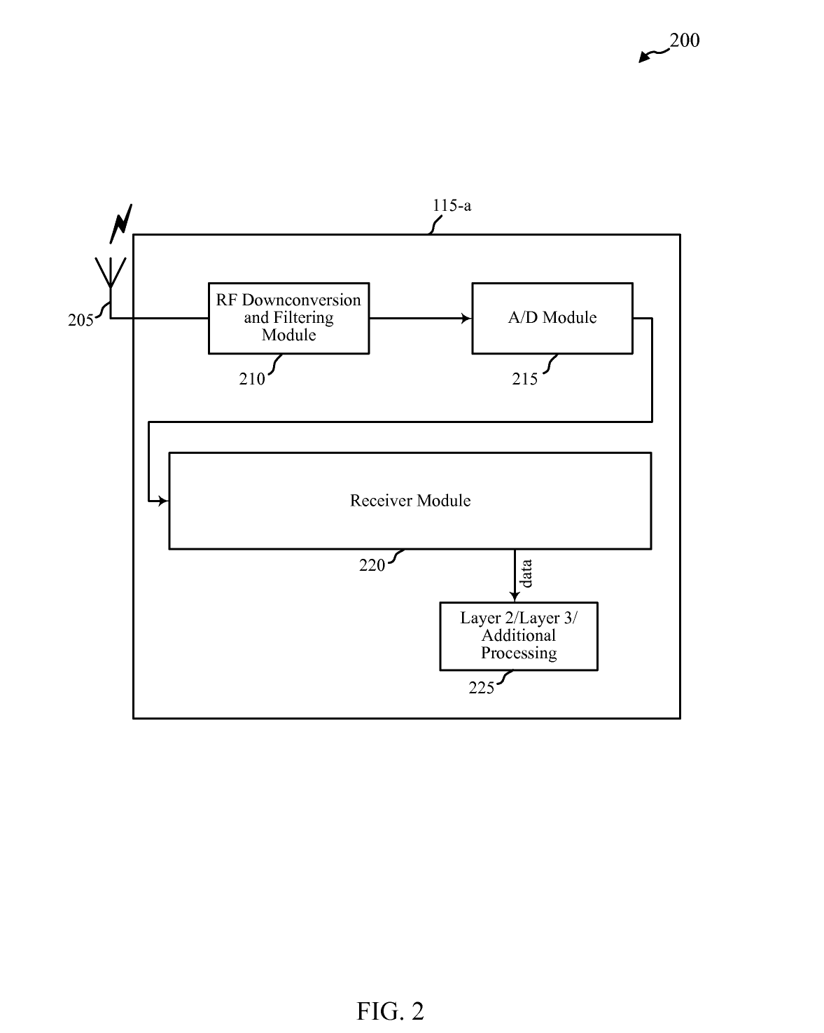

Referring now to FIG. 2, a block diagram 200 illustrates a UE 115-a in accordance with various embodiments. The UE 115-a may be an example of one or more aspects of one of the UEs 115 described with reference to FIG. 1. The UE 115-a may also be a processor. The UE 115-a may include a receive chain including at least one antenna 205, a radio frequency (RF) downconversion and filtering unit module 210, an analog-to-digital converter unit (A/D unit) 215, a receiver module 220, and/or a Layer 2/Layer 3/and/or Additional Processing Module 225. Each of these components may be in communication with each other.

The components of the UE 115-a may be, individually or collectively, implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions stored in a memory, formatted to be executed by one or more general or application-specific processors.

The RF downconversion and filtering unit module 210 may receive, via the at least one antenna 205, an RF data stream including pilot signals and data symbols. The received data stream may be downconverted (i.e., downsampled) and analog filtered by the RF downconversion and filtering unit module 210, and then output to the A/D unit 215. At the A/D unit 215, the data stream may be converted from analog to digital form and output to the receiver module 220. The receiver module 220 may perform various operations on the data stream, including, for example, pilot signal identification, channel estimation, and/or demodulation. Demodulated data symbols may then output to the Layer 2/Layer 3/and/or Additional Processing Module 225.

In some embodiments, the UE 115-a may be or include a cellular device, and in some cases, the receiver module 220 may be or include an LTE/LTE-A receiver module. The receiver module 220 may be used to receive various types of data and/or control signals (i.e., transmissions) over one or more communication channels of a wireless communication system, such as the wireless communications system 100 shown in FIG. 1.

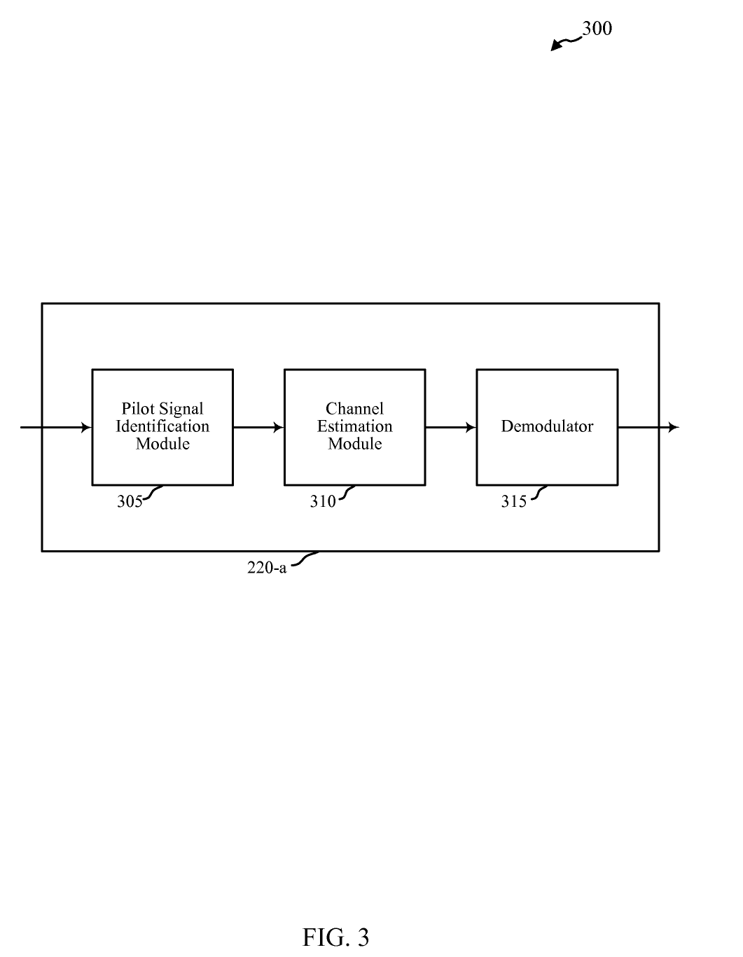

Referring now to FIG. 3, a block diagram 300 illustrates a device 220-a in accordance with various embodiments. The device 220-a may be an example of one or more aspects of the receiver module 220 described with reference to FIG. 2. The device 220-a may also be a processor. The device 220-a may include a pilot signal identification module 305, a channel estimation module 310, and/or a demodulator 315. Each of these components may be in communication with each other.

The components of the device 220-a may be, individually or collectively, implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The pilot signal identification module 305 may receive a data stream and identify the instances of a pilot signal included therein. The pilot signal identification module 305 may also identify the time periods (e.g., frames, half frames, or subframes) in which the instances of the pilot signal occur.

The channel estimation module 310 may estimate a channel based at least in part on the identified instances of the pilot signal. In some cases, the channel estimation module 310 may estimate a channel based on continuous pilot signals. In other cases, the channel estimation module 310 may estimate a channel based on discontinuous pilot signals. By way of example, the instances of the pilot signals may be discontinuous because they occur in first and second time periods separated by a blank period. The blank period may be caused by various circumstances. For example, under some circumstances, the blank period may be caused by a TDD scheme, such as a TDD scheme in which the first and second time periods are allocated for the receipt of pilot signals and/or data by a UE 115, and in which the blank period is allocated for the transmission of pilot signals and/or data by the UE 115. In some embodiments, the TDD scheme may be a TDD scheme supported by an LTE/LTE-A system. In an LTE/LTE-A system, the UE 115 may receive pilot signals and data in downlink (DL) subframes and special subframes (SSFs), but may not receive pilot signals or data in uplink (UL) subframes and certain parts of SSFs. Alternately, and by way of further example, the first and second time periods may be allocated for the receipt of pilot signals and/or data by a UE 115, and the blank period may be allocated for the receipt of pilot signals and/or data by other devices (e.g., other UEs 115 and/or eNBs 105). Under other circumstances, and as a further example, the blank period may be caused by a multimedia broadcast single frequency network (MBSFN) scenario, such as an MBSFN scenario in which an MBSFN signal transmission is received by a UE 115 during the blank period. The blank period may also be caused by a measurement gap scenario, such as a measurement gap scenario in which inter-frequency neighbor cell search and measurement are performed during the blank period.

In still other cases, the channel estimation module 310 may estimate a channel in which one or more data symbols follow a last pilot signal in a particular transmission.

The demodulator 315 may receive the data stream in which the instances of the pilot signal are included and demodulate one or more data symbols included in the data stream, based at least in part on channel estimates provided by the channel estimation module 310. In some cases, the channel estimates may be provided per data symbol and may be interpolated from channel estimates provided for received and/or virtual instances of the pilot signal.

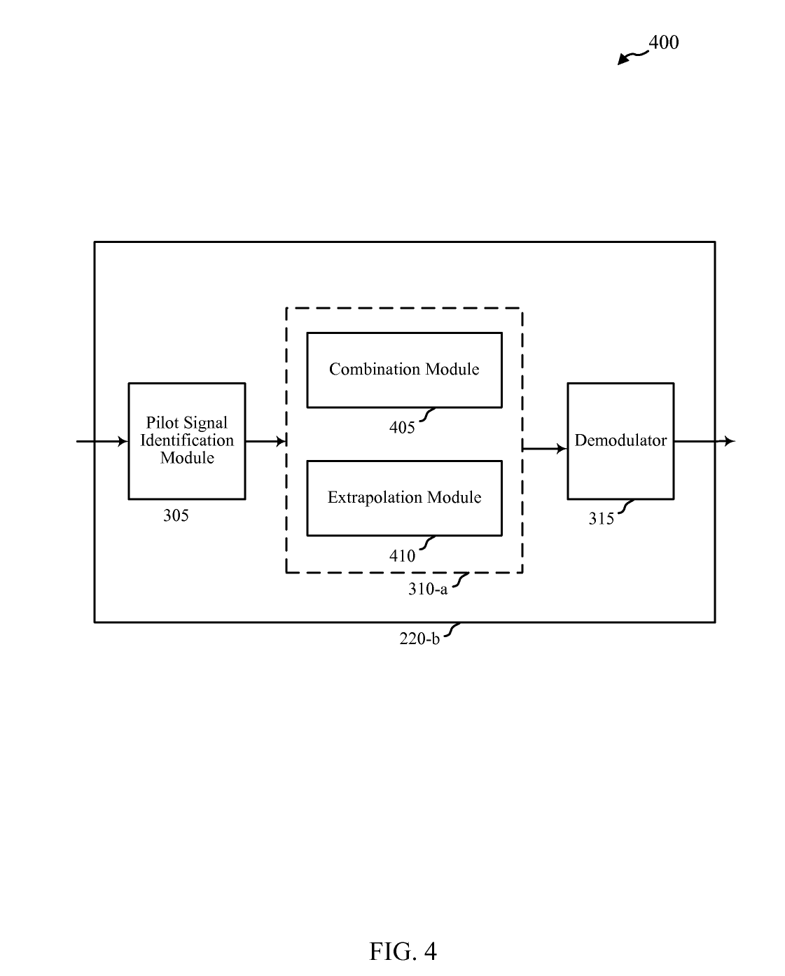

Referring now to FIG. 4, a block diagram 400 illustrates a device 220-b in accordance with various embodiments. The device 220-b may be an example of one or more aspects of the receiver module 220 described with reference to FIGS. 2 and/or 3. The device 220-b may also be a processor. The device 220-b may include a pilot signal identification module 305, a channel estimation module 310-a, and/or a demodulator 315. Each of these components may be in communication with each other.

The components of the device 220-b may be, individually or collectively, implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The pilot signal identification module 305 and demodulator 315 may be configured similarly to what is described with respect to FIG. 3. The channel estimation module 310-a may be an example of the channel estimation module 310 described with reference to FIG. 3 and may include a combination module 405 and/or an extrapolation module 410.

The combination module 405 may combine a first instance of a pilot signal received during a second time period with an instance of the pilot signal received during a first time period. The combination module 405 may then calculate a channel estimate based at least in part on the combination. The second time period may be subsequent to the first time period, and may be separated from the first time period by a blank period. In some cases, instances of the pilot signal may not be received during the blank period, thereby causing the instances of the pilot signal in the first and second time periods to be discontinuous.

In some embodiments, the combination module 405 may further combine a current instance of the pilot signal received during the second time period with a preceding instance of the pilot signal received during the second time period. For example, a second instance of the pilot signal received during the second time period may be combined with the first instance of the pilot signal received during the second time period. Similarly, a third instance may be combined with the second instance, and so on. The channel estimation module 310-a may then calculate a channel estimate based at least in part on each of the combinations.

The extrapolation module 410 may estimate a channel in which one or more data symbols follow a last pilot signal in a particular transmission. For example, the extrapolation module 410 may receive a first instance of a pilot signal and a second instance of the pilot signal from the pilot signal identification module 305. The second instance of the pilot signal may be the last pilot signal of the particular transmission, and the first instance of the pilot signal may temporally precede the second instance of the pilot signal (e.g., the first instance of the pilot signal may be the second to last instance of the pilot signal in the particular transmission). The extrapolation module 410 may calculate a first channel estimate based at least in part on the first instance of the pilot signal, and a second channel estimate based at least in part on the second instance of the pilot signal. The extrapolation module 410 may also extrapolate a third channel estimate corresponding to a virtualized instance of a pilot signal following the second instance of the pilot signal. The third channel estimate may be extrapolated from the first and second channel estimates.

Following receipt of the second instance of the pilot signal, the receiver module 220-b may receive one or more data symbols having timings that fall between the timing of the second instance of the pilot signal and the timing of the virtualized instance of the pilot signal. In some embodiments, the demodulator 315 may interpolate the one or more data symbols based at least upon the second channel estimate and the extrapolated third channel estimate.

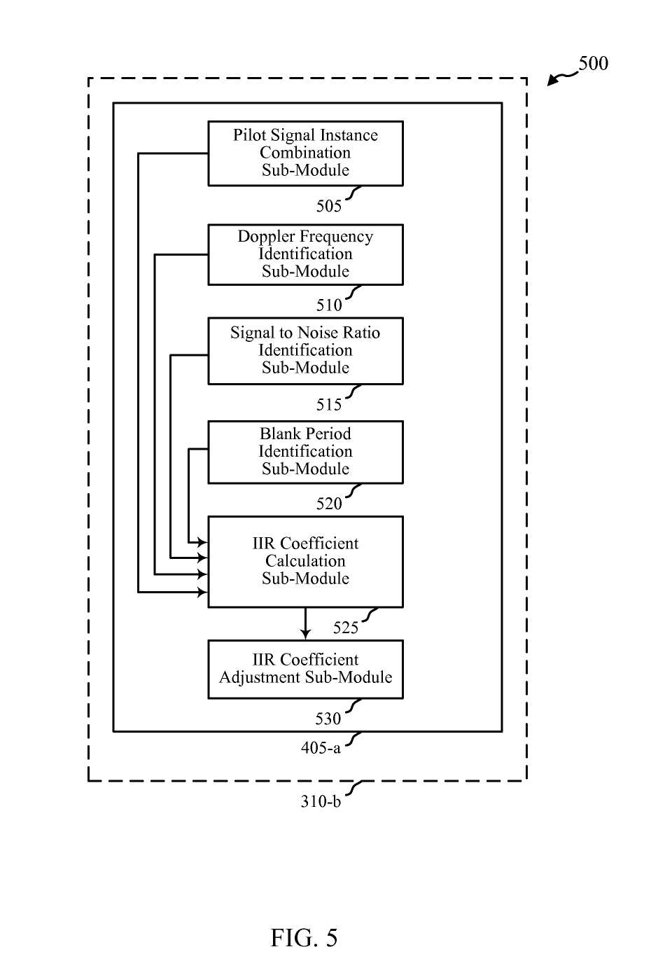

Referring now to FIG. 5, a block diagram 500 illustrates a device 310-b in accordance with various embodiments. The device 310-b may be an example of one or more aspects of the channel estimation module 310 described with reference to FIGS. 3 and/or 4. The device 310-b may also be a processor. The device 310-b may include a combination module 405-a, which may be an example of one or more aspects of the combination module 405 described with reference to FIG. 4.

The combination module 405-a may include a pilot signal instance combination sub-module 505, a Doppler frequency identification sub-module 510, a signal to noise ratio (SNR) identification sub-module 515, a blank period identification sub-module 520, an infinite impulse response (IIR) coefficient calculation sub-module 525, and/or an IIR coefficient adjustment sub-module 530. Each of these components may be in communication with each other.

The pilot signal instance combination sub-module 505 may combine a first instance of a pilot signal received during a second time period with an instance of the pilot signal received during a first time period. The second time period may be subsequent to the first time period, and may be separated from the first time period by a blank period. In some cases, instances of the pilot signal may not be received during the blank period, thereby causing the instances of the pilot signal in the first and second time periods to be discontinuous.

In some embodiments, the pilot signal instance combination sub-module 505 may further combine a current instance of the pilot signal received during the second time period with a preceding instance of the pilot signal received during the second time period. For example, a second instance of the pilot signal received during the second time period may be combined with the first instance of the pilot signal received during the second time period. Similarly, a third instance may be combined with the second instance, and so on.

The Doppler frequency identification sub-module 510 may identify a Doppler frequency of a channel over which the instances of the pilot signal are received. The SNR identification sub-module 515 may identify a SNR of the channel. The blank period identification sub-module 520 may identify a length of the blank period. In some embodiments, the length of the blank period may be identified at least in part based on a number of unreceived pilot signals during the blank period.

The combined instances of the pilot signal, Doppler frequency, SNR, and length of the blank period may be provided to the IIR coefficient calculation sub-module 525. The IIR coefficient calculation sub-module 525 may then calculate an IIR coefficient for each instance of the pilot signal received during the second time period. An IIR coefficient for a given instance of a pilot signal may then be calculated, in some cases, as a function of at least the combined instances of the pilot signal corresponding to the given instance, the Doppler frequency, the SNR, and the length of the blank period.

The IIR coefficient adjustment sub-module 530 may adjust at least one IIR coefficient of an IIR filter for the pilot signals, based at least in part on the calculated IIR coefficient(s).

The channel estimation module 310-b may calculate a channel estimate based at least in part on each of the adjusted IIR coefficients of the IIR filter.

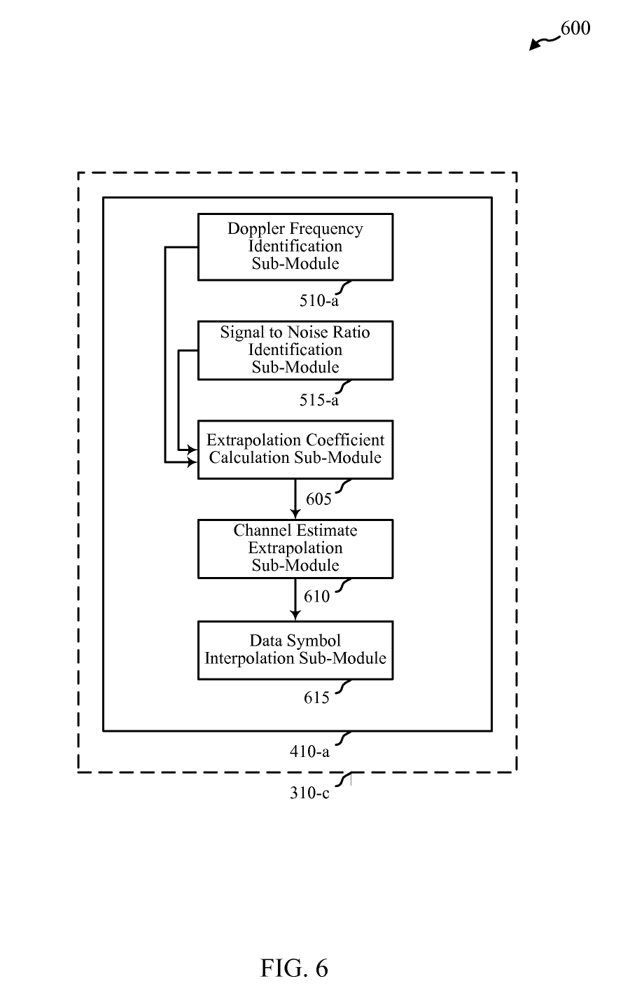

Referring now to FIG. 6, a block diagram 600 illustrates a device 310-c in accordance with various embodiments. The device 310-c may be an example of one or more aspects of the channel estimation module 310 described with reference to FIGS. 3 and/or 4. The device 310-c may also be a processor. The device 310-c may include an extrapolation module 410-a, which may be an example of one or more aspects of the extrapolation module 410 described with reference to FIG. 4.

In some embodiments, the channel estimation module 310-c may receive a first instance of a pilot signal and calculate a first channel estimate based at least in part on the first instance of the pilot signal. The channel estimation module 310-c may also receive a second instance of a pilot signal and calculate a second channel estimate based at least in part on the second instance of the pilot signal. The second instance of the pilot signal may be received after the first instance of the pilot signal. One or more data symbols may be received following receipt of the second instance of the pilot signal.

In some cases, the first and second channel estimates may be based on a first filtered channel impulse response (CIR) and a second CIR, respectively. In other cases, the first and second channel estimates may be based on a first unfiltered CIR and a second unfiltered CIR, respectively.

The extrapolation module 410-a may include a Doppler frequency identification sub-module 510-a, a signal to noise ratio (SNR) identification sub-module 515-a, an extrapolation coefficient calculation sub-module 605, a channel estimate extrapolation sub-module 610, and/or a data symbol interpolation sub-module 615.

The Doppler frequency identification sub-module 510-a may identify a Doppler frequency of a channel over which the instances of the pilot signal are received. The SNR identification sub-module 515-a may identify a SNR of the channel.

The Doppler frequency and SNR may be provided to the extrapolation coefficient calculation sub-module 605. The extrapolation coefficient calculation sub-module 605 may then calculate an extrapolation coefficient as a function of at least the Doppler frequency and the SNR. In some cases, the extrapolation coefficient may be increased as the Doppler frequency increases, and decreased as the Doppler frequency decreases. In some cases, the extrapolation coefficient may be increased as the SNR increases, and decreased as the SNR decreases.

The channel estimate extrapolation sub-module 610 may extrapolate a third channel estimate from the first and second channel estimates (or any number of two or more channel estimates). The third channel estimate may correspond to a virtualized pilot signal following the second instance of the pilot signal. In one embodiment, the extrapolation coefficient may be applied to a linear combination of the first and second channel estimates.

In some embodiments, at least the second channel estimate and the extrapolated third channel estimate may be provided to the data symbol interpolation sub-module 615. The data symbol interpolation sub-module 615 may use the channel estimates to interpolate the one or more data symbols received following receipt of the second instance of the pilot symbol. In one configuration, the channel estimates may be passed to a demodulator (e.g., the demodulator 315 described with reference to FIGS. 3 and/or 4) that may use the channel estimates to interpolate the one or more data symbols. In some embodiments, the one or more interpolated data symbols may have timings that fall between the timing of the second instance of the pilot signal and the timing of the virtualized instance of the pilot signal.

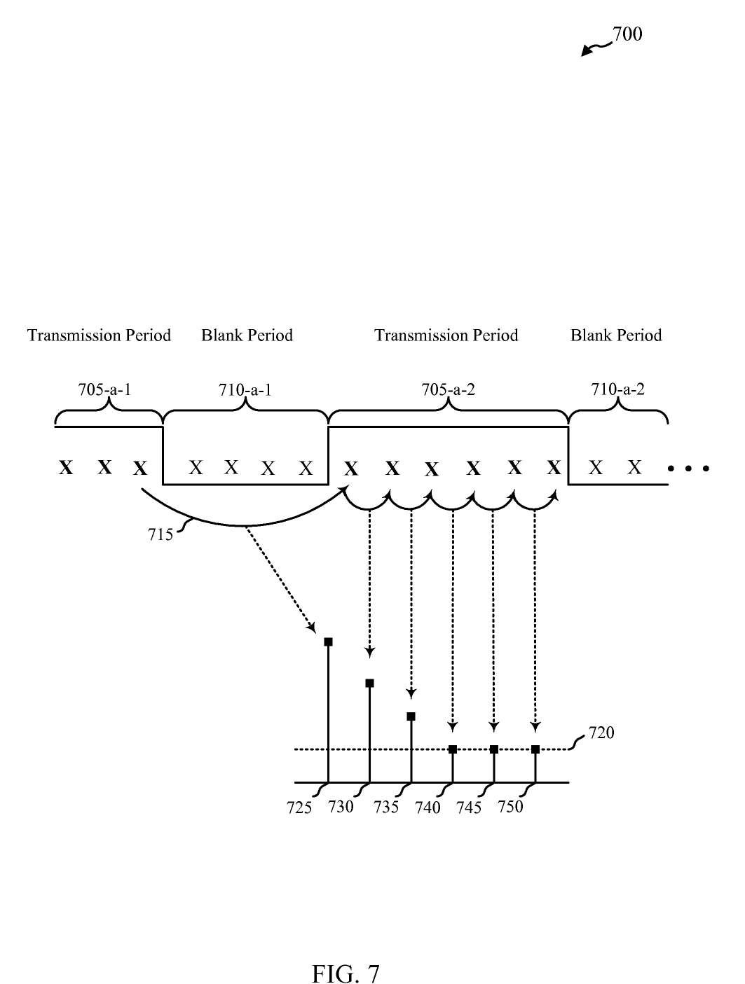

FIG. 7 illustrates a timing diagram 700. The timing diagram 700 shows one example of how a UE such as one of the UEs 115 described with reference to FIGS. 1, 2, 3, 4, and/or 5 may receive discontinuous instances of a pilot signal and provide useful channel estimates based on the pilot signals. In particular, the timing diagram 700 shows that a UE 115 may receive discontinuous instances of a pilot signal, each of which is denoted by an “X” in FIG. 7. A first number of instances of the pilot signal may be received during a first time period 705-a-1 (e.g., during receipt of a first one or more DL subframes). A second number of instances of the pilot signal may be received during a second time period 705-a-2 (e.g., during receipt of a second one or more DL subframes). However, between the first and second time periods 705-a-1, 705-a-2, there exists a blank period 710-a-1 in which no instance of the pilot signal may be received. In some embodiments, the blank period 710-a-1 may be caused by a TDD scheme, a DRX scheme, or a Multimedia Broadcast Single-Frequency Network (MBSFN). By way of example, another blank period 710-a-2 may follow the second time period 705-a-2. In some embodiments, each blank period 710-a-1 and 710-a-2 may represent a time period occupied by one or more UL subframes or a measurement gap.

Because of the blank period 710-a-1, an IIR filter having a fixed coefficient (e.g., an IIR filter used for estimating a channel based on a continuous instances of a pilot signal) may not be in a steady-state when used to generate channel estimates for the second time period 705-a-2, and hence, it may lead to errant channel estimates during the receipt of the pilot signal instances included in the second time period 705-a-2. The IIR coefficient suitable for estimating a channel based on a discontinuous pilot signal may be time-variant, as shown in FIG. 7. In order to average the noise out from the instances of the pilot signal during the second time period, a first instance of the pilot signal received during the second time period may be combined with an instance of the pilot signal received during the first time period, as shown by arrow 715. The channel may then be estimated based at least in part on the combination. The channel estimation may in some cases include calculating an IIR coefficient 725 corresponding to the first instance of the pilot signal received during the second time period. The IIR coefficient may be based on the combination of pilot signal instances, and may be a function of the length of the blank period, as well as a Doppler frequency and SNR of the channel.

Channel estimation may further include calculating an IIR coefficient 725, 730, 735, 740, 745, 750 corresponding to each instance of the pilot signal received during the second time period 705-a-2. In some embodiments, the IIR coefficients and their corresponding group delays may be jointly optimized using a minimum mean-square error (MMSE) criterion. For example, the sum of the mean square error between the actual channel gains and the filtered channel estimates may be minimized with respect to all IIR coefficients applied to the instances of the pilot signal in the second time period. The optimized IIR coefficients may be applied repeatedly to all non-blank time periods. The trend of the calculated IIR coefficients may begin with a larger IIR coefficient and decay toward a steady-state IIR coefficient 720.

As shown above, the optimal IIR coefficients may be functions of Doppler frequency and SNR. As a result, optimal IIR coefficients for each combination of Doppler frequency and SNR may be stored in a two-dimensional look-up table. In a TDD context, a two-dimensional look-up table may be stored for each common pilot signal (or common reference signal (CRS)), and for each UL and DL subframe configuration. To save memory for the look-up table(s), an optimal IIR coefficient may be approximated by an “Equal Weight Update” (EWU) rule, where, for example, the contributions from each instance of a pilot signal are kept equal given an arbitrary IIR coefficient. Such IIR coefficients may be given by the equation:

$${∝}_{i} = max ( \frac{{∝}_{0}}{1 + i {∝}_{0}} , {∝}_{ss} ) , i = 0 , 1 , …$$

where αᵢ denotes the IIR coefficient for the (i+1)th pilot instance during the second time period and αₛₛ denotes the steady-state IIR coefficient obtained based on a continuous pilot signal assumption. Assuming that the optimal IIR coefficient will converge to a steady-state, a maximum between the EWU IIR coefficient and the steady-state IIR coefficient may be used.

Owing to approximation, optimization of the IIR coefficients may be done only over a single parameter, ∝ₒ (the initial IIR coefficient under the constraint given by EWU). In this manner, the number of look-up tables may be reduced.

In some embodiments, the channel estimation illustrated with reference to FIG. 7 may be performed by the combination module 405 described with reference to FIGS. 4 and/or 5.

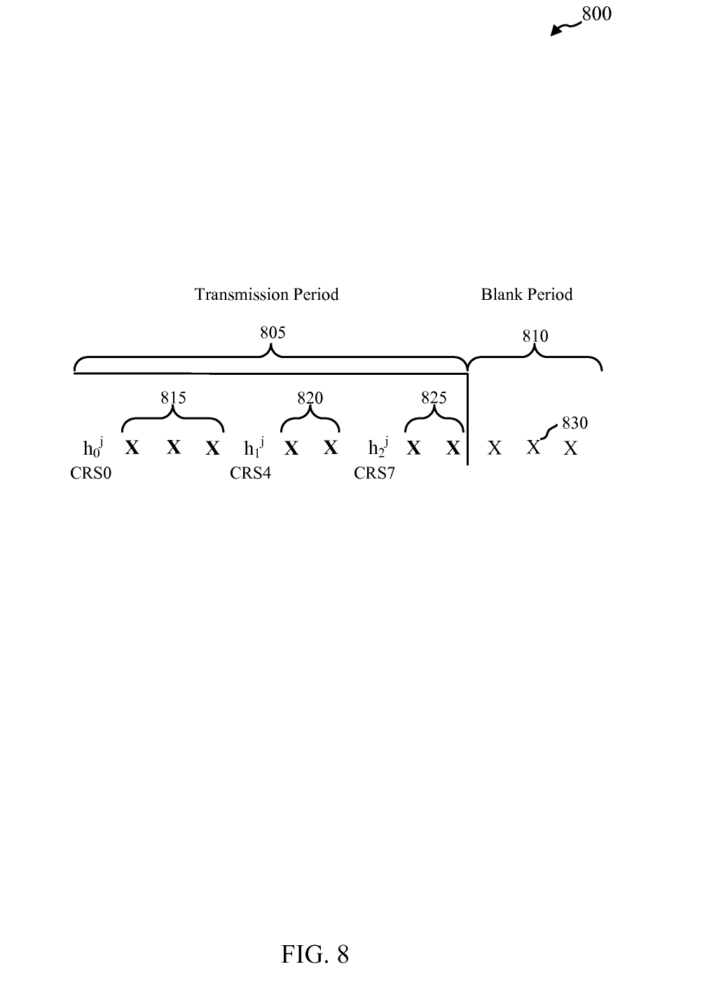

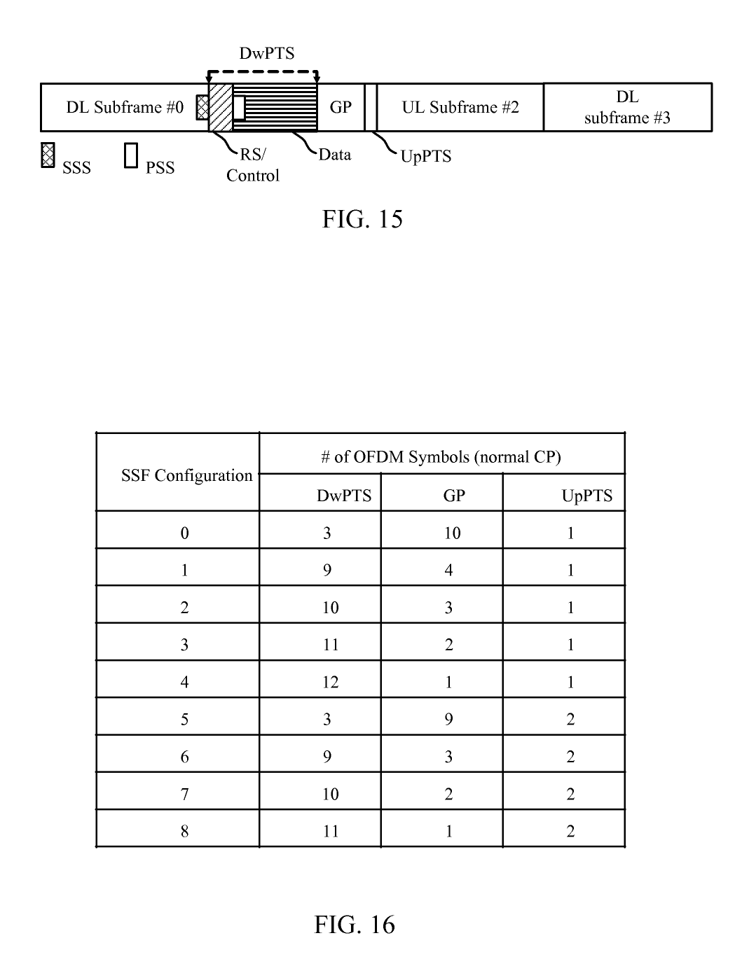

FIG. 8 illustrates a timing diagram 800. The timing diagram 800 shows one example of how a UE such as one of the UEs 115 described with reference to FIGS. 1, 2, 3, 4, and/or 6 may estimate a channel in which one or more data symbols follow a last instance of a pilot signal (e.g., a last instance of a pilot signal in a particular transmission). In particular, the timing diagram 800 shows that a UE 115 may receive the instances of the pilot signal h₀^{j}, h₁^{j}, h₂^{j}. In some embodiments, the instances of the pilot signal may be received during a DL transmission period 805 of a special subframe (SSF), which in the case of FIG. 8 is shown to be a SSF Configuration 7 of the LTE/LTE-A standard. In such a context, the instances of the pilot signal h₀^{j}, h₁^{j}, h₂^{j} may respectively correspond to CRS0, CRS4, and CRS7, and the DL transmission period 805 may correspond to a Downlink Pilot Time Slot (DwPTS) portion of the SSF Configuration 7. In TDD, a special subframe may be used to provide a guard time for downlink-uplink switching. The switch between downlink and uplink may occur in the special subframe (e.g., subframe 1 and, in some cases, subframe 6). FIG. 15 illustrates an example TDD SSF configuration. FIG. 16 is a table illustrating example OFDM symbol allocations among the DwPTS portion of an SSF, a gap (GP) portion (GP), and an Uplink Pilot Time Slot (UpPTS) portion for different SSF configurations.

One or more data symbols, each of which is denoted by an “X” in FIG. 8, may fall between ones of the received instances of the pilot signal (e.g., those in data symbol groups 815 and 820) and may be interpolated based on the channel estimates calculated for their bounding instances of the pilot signal. However, one or more data symbols (e.g., those in data symbol group 825) may follow the last received instance of the pilot signal. Although the data symbols may be interpolated based on a channel estimate calculated for the last received instance of the pilot signal (e.g., CRS7), this may result in a degraded channel estimation, for example, in the case of high Doppler frequency.

In order to improve channel estimation and better interpolate the data symbols, a channel estimate for a virtualized instance of the pilot signal 830 may be calculated. A timing of the virtualized instance of the pilot signal 830 may be selected to be during a blank period 810 following the DL transmission period 805. In the case of a subframe having SSF Configuration 7, the blank subframe may correspond to a UL transmission period of the SSF. In the example shown, the timing of the virtualized instance of the pilot signal 830 may correspond with a timing of an unreceived CRS11.

In some embodiments, the channel estimate for the virtualized instance of the pilot signal 830 may be extrapolated based on two or more previous channel estimates. In other embodiments, the channel estimate for the virtualized instance of the pilot signal 830 may be extrapolated based on two or more previous raw CIRs for the virtualized instance of the pilot signal 830, and then applying IIR filtering to the extrapolated raw CIR.

When two previous channel estimates are used for extrapolation, a filtered CIR_{w}_{₃}_{^{j}}^{A} for the virtualized instance of the pilot signal may be extrapolated as follows:

ŵ₃_{^{j}}=w₂_{^{j}}+αₑₓₜ(w₂_{^{j}}−w₁_{^{j}})

where ŵ{circumflex over (w₁_{^{j}})} and ŵ{circumflex over (w₂_{^{j}})} denote the filtered CIRs for the first and second instances of the pilot signal, respectively, and αₑₓₜ denotes an extrapolated IIR coefficient.

When two previous raw CIRs are used for extrapolation, a raw CIR may be extrapolated as follows:

ĝ₃^{j}=g₂^{j}+αₑₓₜ(g₂^{j}−g₁^{j})

where ĝ{circumflex over (g₁_{^{j}})} and ŵ{circumflex over (w₂_{^{j}})} denote the raw CIRs for the first and second instances of the pilot signal, respectively, and αₑₓₜ denotes an extrapolated IIR coefficient.

In either case, an improved IIR coefficient αₑₓₜ^{opt} may be calculated jointly with the IIR coefficients α₀, α₁, . . . , α_{L-1} in an MMSE sense using the following equation:

$$( {α}_{0}^{opt} , … , {α}_{L - 1}^{opt} , {α}_{ext}^{opt} ) = {arg min}_{{α}_{0} , … , {α}_{L - 1} , {α}_{ext}} {MSE}_{{f}_{d} , SNR} ( {α}_{0} , … , {α}_{L - 1} , {α}_{ext} )$$

In some embodiments, the channel estimation illustrated with reference to FIG. 8 may be performed by the extrapolation module 410 described with reference to FIGS. 4 and/or 6.

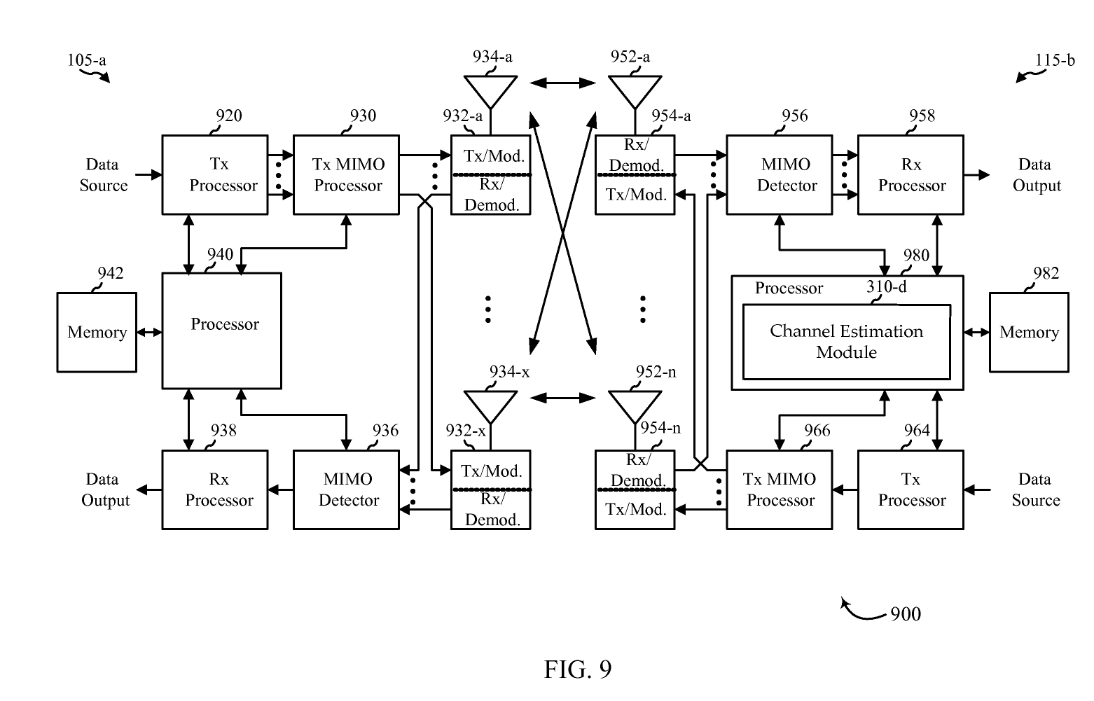

FIG. 9 is a block diagram of a MIMO communication system 900 including a base station 105-a and a UE 115-b. This system 900 may illustrate aspects of the system 100 of FIG. 1. The base station 105-a may be equipped with antennas 934-a through 934-x, and the UE 115-b may be equipped with antennas 952-a through 952-n. In the system 900, the base station 105-a may be able to send data over multiple communication links at the same time. Each communication link may be called a “layer.” The “rank” of the communication link may indicate a number of layers used for communication. For example, in a 2×2 MIMO system where base station 105-a transmits two “layers,” the rank of the communication link between the base station 105-a and the UE 115-b is two.

At the base station 105-a, a transmit processor 920 may receive data from a data source. The transmit processor 920 may process the data. The transmit processor 920 may also generate control symbols and/or reference symbols. A transmit (TX) MIMO processor 930 may perform spatial processing (e.g., precoding) on data symbols, control symbols, and/or reference symbols, if applicable, and may provide output symbol streams to the transmit modulators 932-a through 932-x. Each modulator 932 may process a respective output symbol stream (e.g., for OFDM, etc.) to obtain an output sample stream. Each modulator 932 may further process (e.g., convert to analog, amplify, filter, and upconvert) the output sample stream to obtain a DL signal. In one example, DL signals from modulators 932-a through 932-x may be transmitted via the antennas 934-a through 934-x, respectively.

At the UE 115-b, the UE antennas 952-a through 952-n may receive the DL signals from the base station 105-a and may provide the received signals to the demodulators 954-a through 954-n, respectively. Each demodulator 954 may condition (e.g., filter, amplify, downconvert, and digitize) a respective received signal to obtain input samples. Each demodulator 954 may further process the input samples (e.g., for OFDM, etc.) to obtain received symbols. A MIMO detector 956 may obtain received symbols from all the demodulators 954-a through 954-n, perform MIMO detection on the received symbols, if applicable, and provide detected symbols. A receive processor 958 may process (e.g., demodulate, deinterleave, and decode) the detected symbols, providing decoded data for the UE 115-b to a data output, and provide decoded control information to a processor 980 or memory 982.

The processor 980 may in some cases execute stored instructions to instantiate a channel estimation module 310-d. In some embodiments, the channel estimation module 310-d may estimate a channel with discontinuous instances of a pilot signal, as described with reference to FIGS. 4, 5, and/or 7. In other embodiments, the channel estimation module 310-d may estimate a channel in which one or more data symbols follow a last instance of a pilot signal in a particular transmission, as described with reference to FIGS. 4, 6, and/or 8.

On the uplink (UL), at the UE 115-b, a transmit processor 964 may receive and process data from a data source. The received data may in some cases include the estimated characteristic(s) of one or more communication channels. The transmit processor 964 may also generate reference symbols for a reference signal. The symbols from the transmit processor 964 may be precoded by a transmit MIMO processor 966 if applicable, further processed by the demodulators 954-a through 954-n (e.g., for SC-FDMA, etc.), and be transmitted to the base station 105-a in accordance with the transmission parameters received from the base station 105-a. At the base station 105-a, the UL signals from the UE 115-b may be received by the antennas 934, processed by the demodulators 932, detected by a MIMO detector 936 if applicable, and further processed by a receive processor 938. The receive processor 938 may provide decoded data to a data output and to the processor 940.

The components of the UE 115-b may be, individually or collectively, implemented with one or more Application Specific Integrated Circuits (ASICs) adapted to perform some or all of the applicable functions in hardware. Each of the noted modules may be a means for performing one or more functions related to operation of the system 900. Similarly, the components of the base station 105-a may be, individually or collectively, implemented with one or more Application Specific Integrated Circuits (ASICs) adapted to perform some or all of the applicable functions in hardware. Each of the noted components may be a means for performing one or more functions related to operation of the system 900.

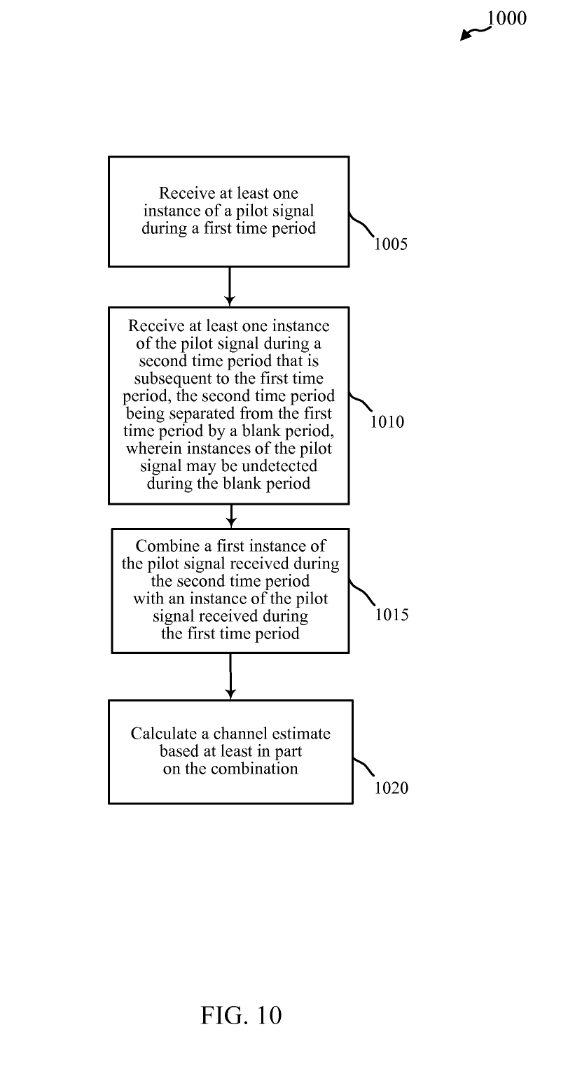

FIG. 10 is a flow chart illustrating an embodiment of a method 1000 for estimating a channel with discontinuous pilot signals. For clarity, the method 1000 is described below with reference to the wireless communications system 100 or 900 shown in FIGS. 1 and/or 9, and/or with reference to one of the UEs 115 or components thereof described with reference to FIGS. 1, 2, 3, 4, 5, and/or 9. In one implementation, the channel estimation module 310 described with reference to FIGS. 3, 4, 5, and/or 9 may execute one or more sets of codes to control the functional elements of a UE 115 to perform the functions described below.

At block 1005, at least one instance of a pilot signal may be received during a first time period.

At block 1010, at least one instance of the pilot signal may be received during a second time period. The second period may be subsequent to the first time period, and may be separated from the first time period by a blank period. Instances of the pilot signal may go undetected during the blank period.

In some embodiments, the first time period, the blank period, and the second time period may each correspond to a number of (i.e., one or more) subframes of a TDD scheme, such as a number of subframes supported by an LTE/LTE-A system.

The blank period between the first and second time periods may be caused by various circumstances. For example, under some circumstances, the blank period may be caused by a TDD scheme, such as a TDD scheme in which the first and second time periods are allocated for the receipt of pilot signals and/or data by a UE 115, and in which the blank period is allocated for the transmission of pilot signals and/or data by the UE 115. In some embodiments, the TDD scheme may be a TDD scheme supported by an LTE/LTE-A system. In an LTE/LTE-A system, the UE 115 may receive pilot signals and data in downlink (DL) subframes and special subframes (SSFs), but may not receive pilot signals or data in uplink (UL) subframes and certain parts of SSFs. Alternately, and by way of further example, the first and second time periods may be allocated for the receipt of pilot signals and/or data by a UE 115, and the blank period may be allocated for the receipt of pilot signals and/or data by other devices (e.g., other UEs 115 and/or eNBs 105). Under other circumstances, and as a further example, the blank period may be caused by a DRX scheme, such as a DRX scheme in which pilot signals and/or data are received by a UE 115 during the first and second time periods, but not during the blank period.

The instances of the pilot signal received during the first and second time periods may in some cases be received by the receiver module 220 and/or the pilot signal identification module 305 described with reference to FIGS. 2, 3, and/or 4. In some cases, the instances of the pilot signal may be received under control of the channel estimation module 310, and/or the receiver module 220 and/or the pilot signal identification module 305 may be operated under control of the channel estimation module 310.

At block 1015, a first instance of the pilot signal received during the second time period may be combined with an instance of the pilot signal received during the first time period. In some embodiments, the combining performed at block 1015 may be performed by the channel estimation module 310 described with reference to FIGS. 3, 4, and/or 9, and/or the combination module 405 described with reference to FIGS. 4 and/or 5.

At block 1020, a channel estimate may be calculated based at least in part on the combination made at block 1015. In some embodiments, the channel estimate calculated at block 1020 may be calculated using the channel estimation module 310 described with reference to FIGS. 3, 4, and/or 9, and/or the combination module 405 described with reference to FIGS. 4 and/or 5.

Therefore, the method 1000 may be used for estimating a channel with discontinuous pilot signals. It should be noted that the method 1000 is just one implementation and that the operations of the method 1000 may be rearranged or otherwise modified such that other implementations are possible.

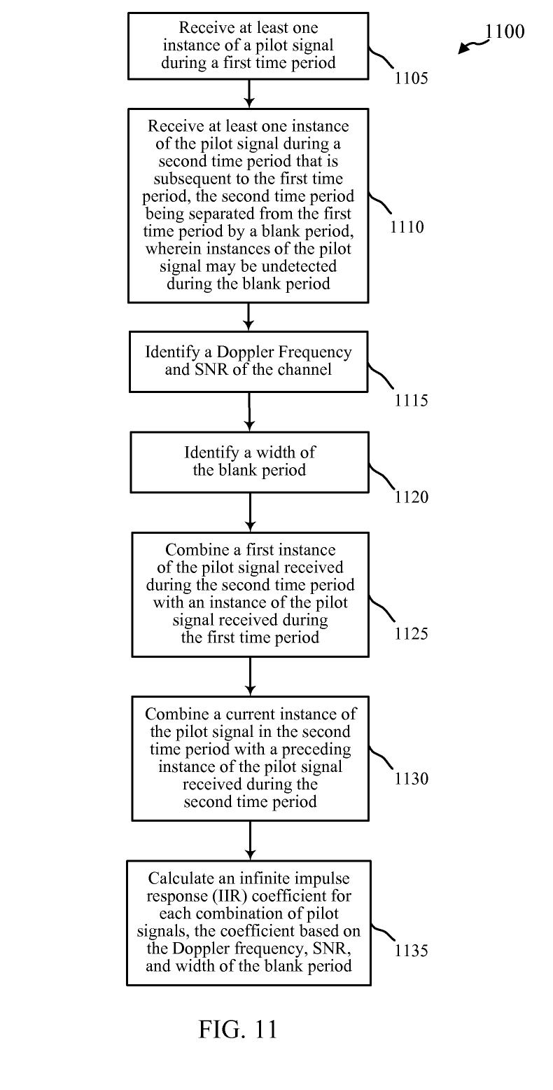

FIG. 11 is a flow chart illustrating an embodiment of another method 1100 for estimating a channel with discontinuous pilot signals. For clarity, the method 1100 is described below with reference to the wireless communications system 100 or 900 shown in FIGS. 1 and/or 9, and/or with reference to one of the UEs 115 or components thereof described with reference to FIGS. 1, 2, 3, 4, 5, and/or 9. In one implementation, the channel estimation module 310 described with reference to FIGS. 3, 4, 5, and/or 9 may execute one or more sets of codes to control the functional elements of a UE 115 to perform the functions described below.

At block 1105, at least one instance of a pilot signal may be received during a first time period.

At block 1110, at least one instance of the pilot signal may be received during a second time period. The second period may be subsequent to the first time period, and may be separated from the first time period by a blank period. Instances of the pilot signal may go undetected during the blank period.

In some embodiments, the first time period, the blank period, and the second time period may each correspond to a number of (i.e., one or more) subframes of a TDD scheme, such as a number of subframes supported by an LTE/LTE-A system.

The blank period between the first and second time periods may be caused by various circumstances. For example, under some circumstances, the blank period may be caused by a TDD scheme, such as a TDD scheme in which the first and second time periods are allocated for the receipt of pilot signals and/or data by a UE 115, and in which the blank period is allocated for the transmission of pilot signals and/or data by the UE 115. In some embodiments, the TDD scheme may be a TDD scheme supported by an LTE/LTE-A system. In an LTE/LTE-A system, the UE 115 may receive pilot signals and data in downlink (DL) subframes and special subframes (SSFs), but may not receive pilot signals or data in uplink (UL) subframes and certain parts of SSFs. Alternately, and by way of further example, the first and second time periods may be allocated for the receipt of pilot signals and/or data by a UE 115, and the blank period may be allocated for the receipt of pilot signals and/or data by other devices (e.g., other UEs 115 and/or eNBs 105). Under other circumstances, and as a further example, the blank period may be caused by a DRX scheme, such as a DRX scheme in which pilot signals and/or data are received by a UE 115 during the first and second time periods, but not during the blank period.

The instances of the pilot signal received during the first and second time periods may in some cases be received by the receiver module 220 and/or the pilot signal identification module 305 described with reference to FIGS. 2, 3, and/or 4. In some cases, the instances of the pilot signal may be received under control of the channel estimation module 310, and/or the receiver module 220 and/or the pilot signal identification module 305 may be operated under control of the channel estimation module 310.

At block 1115, a Doppler frequency of a channel over which the instances of the pilot signal are received may be identified. An SNR of the channel may also be identified. In some embodiments, the operations at block 1115 may be performed by the channel estimation module 310 described with reference to FIGS. 3, 4, and/or 9, and/or the combination module 405 described with reference to FIGS. 4 and/or 5, and/or the Doppler frequency identification sub-module 510 and signal to noise ratio identification sub-module 515 described with reference to FIG. 5.

At block 1120, a length of the blank period may be identified. The length of the blank period may in some cases be identified based at least in part on a number of unreceived pilot signals during the blank period. In some embodiments, the operations at block 1120 may be performed by the channel estimation module 310 described with reference to FIGS. 3, 4, and/or 9, and/or the combination module 405 described with reference to FIGS. 4 and/or 5, and/or the blank period identification sub-module 520 described with reference to FIG. 5.

At block 1125, a first instance of the pilot signal received during the second time period may be combined with an instance of the pilot signal received during the first time period. Similarly, and at block 1130, a current instance of the pilot signal received in the second time period may be combined with a preceding instance of the pilot signal received during the second time period. For example, a second instance of the pilot signal received during the second time period may be combined with the first instance of the pilot signal received during the second time period. Similarly, a third instance may be combined with the second instance, and so on. In some embodiments, the combining performed at blocks 1125 and 1130 may be performed by the channel estimation module 310 described with reference to FIGS. 3, 4, and/or 9, and/or the combination module 405 described with reference to FIGS. 4 and/or 5.

At block 1135, an IIR coefficient corresponding to each of 1) the first instance of the pilot signal received during the second time period, 2) the second instance of the pilot signal received during the second time period, and 3) any other instances of the pilot signal received during the second time period may be calculated (e.g., an IIR coefficient may be calculated for each combination of pilot signals made in blocks 1125 and 1130). Each IIR coefficient may be a function of at least the Doppler frequency, the SNR, and the length of the blank period. The IIR coefficient may provide a means to estimate the channel.

In some embodiments, the IIR coefficient corresponding to the second instance of the pilot signal received during the second period may be less than the IIR coefficient corresponding to the first instance of the pilot signal received during the second period. When more than two instances of the pilot signal have been received, the IIR coefficient corresponding to each subsequent instance of the pilot signal may decay with respect to a previous IIR coefficient, until a steady-state IIR coefficient is reached.

In some embodiments, the IIR coefficient(s) calculated at block 1135 may be calculated by the channel estimation module 310 described with reference to FIGS. 3, 4, and/or 9, and/or the combination module described with reference to FIGS. 4 and/or 5, and/or the IIR coefficient calculation sub-module 525 described with reference to FIG. 5.

Therefore, the method 1100 may be used for estimating a channel with discontinuous pilot signals. It should be noted that the method 1100 is just one implementation and that the operations of the method 1100 may be rearranged or otherwise modified such that other implementations are possible.

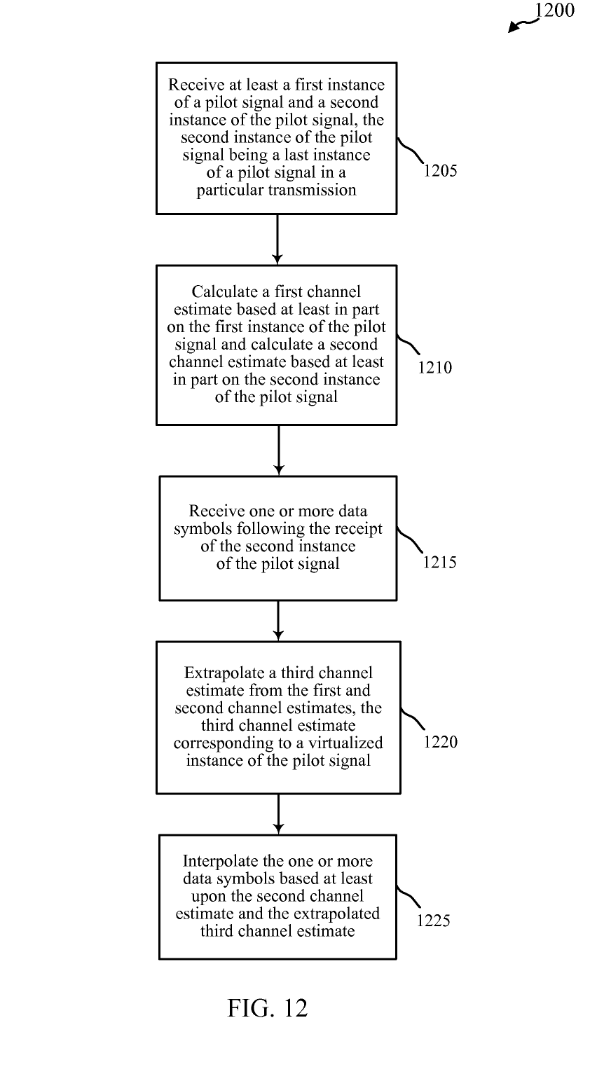

FIG. 12 is a flow chart illustrating an embodiment of a method 1200 for estimating a channel in which one or more data symbols follow a last instance of a pilot signal in a particular transmission. For clarity, the method 1200 is described below with reference to the wireless communications system 100 or 900 shown in FIGS. 1 and/or 9, and/or with reference to one of the UEs 115 or components thereof described with reference to FIGS. 1, 2, 3, 4, 6, and/or 9. In one implementation, the channel estimation module 310 described with reference to FIGS. 3, 4, 6, and/or 9 may execute one or more sets of codes to control the functional elements of a UE 115 to perform the functions described below.

At block 1205, at least a first instance of a pilot signal and a second instance of a pilot signal may be received. The second instance of the pilot signal may be received after the first instance of the pilot signal. The second instance of the pilot signal may be the last instance of the pilot signal in the particular transmission, and the first instance of the pilot signal may temporally precede the second instance of the pilot signal (e.g., the first instance of the pilot signal may be the second to last instance of the pilot signal in the particular transmission). In some cases, the first and second instances of the pilot signal may be received during the same subframe. For example, the first and second instances of the pilot signal may be received during a DL transmission period of a subframe such as a special subframe (SSF).

The first and second instances of the pilot signal may in some cases be received by the receiver module 220 and/or the pilot signal identification module 305 described with reference to FIGS. 2, 3, and/or 4. In some cases, the instances of the pilot signal may be received under control of the channel estimation module 310, and/or the receiver module 220 and/or the pilot signal identification module 305 may be operated under control of the channel estimation module 310.

At block 1210, a first channel estimate may be calculated based at least in part on the first instance of the pilot signal, and a second channel estimate may be calculated based at least in part on the second instance of the pilot signal. In some embodiments, the channel estimates calculated at block 1210 may be calculated using the channel estimation module 310 described with reference to FIGS. 3, 4, and/or 9, and/or the combination module 405 described with reference to FIGS. 4 and/or 6.

At block 1215, one or more data symbols may be received following receipt of the second instance of the pilot signal. The data symbols may in some cases be received by the receiver module 220 and/or the demodulator 315 described with reference to FIGS. 2, 3, and/or 4. In some cases, the one or more data symbols may be received under control of the channel estimation module 310, and/or the receiver module 220.

At block 1220, a third channel estimate may be extrapolated from the first and second channel estimates. The third channel estimate may correspond to a virtualized instance of the pilot signal following the second instance of the pilot signal. In some cases, a timing of the virtualized pilot signal may be selected to be during a blank period following the second instance of the pilot signal. In some cases, the blank period may be a UL transmission period of a subframe such as a SSF. The UL transmission period may sometimes be part of the same SSF in which the first and second instances of the pilot signal are received, and may follow a DL transmission period of the SSF.

At block 1225, the one or more data symbols received after the second instance of the pilot signal may be interpolated based at least upon the second channel estimate and the extrapolated third channel estimate.

Therefore, the method 1200 may be used for estimating a channel in which one or more data symbols follow a last instance of a pilot signal in a particular transmission. It should be noted that the method 1200 is just one implementation and that the operations of the method 1200 may be rearranged or otherwise modified such that other implementations are possible.

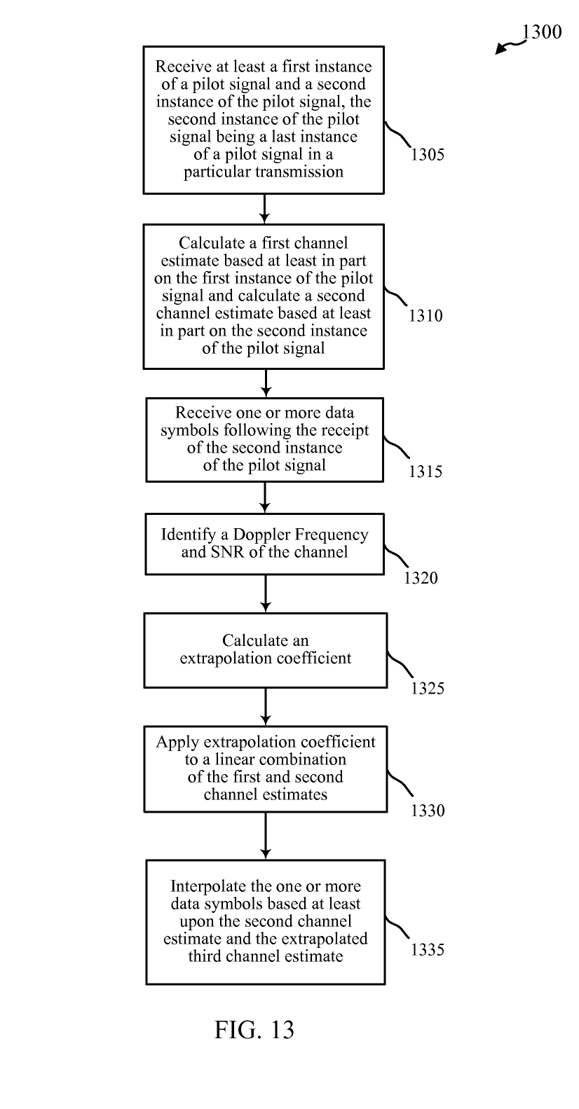

FIG. 13 is a flow chart illustrating an embodiment of another method 1300 for estimating a channel in which one or more data symbols follow a last instance of a pilot signal in a particular transmission. For clarity, the method 1300 is described below with reference to the wireless communications system 100 or 900 shown in FIGS. 1 and/or 9, and/or with reference to one of the UEs 115 or components thereof described with reference to FIGS. 1, 2, 3, 4, 6, and/or 9. In one implementation, the channel estimation module 310 described with reference to FIGS. 3, 4, 6, and/or 9 may execute one or more sets of codes to control the functional elements of a UE 115 to perform the functions described below.

At block 1305, at least a first instance of a pilot signal and a second instance of a pilot signal may be received. The second instance of the pilot signal may be received after the first instance of the pilot signal. The second instance of the pilot signal may be the last instance of the pilot signal in the particular transmission, and the first instance of the pilot signal may temporally precede the second instance of the pilot signal (e.g., the first instance of the pilot signal may be the second to last instance of the pilot signal in the particular transmission). In some cases, the first and second instances of the pilot signal may be received during the same subframe. For example, the first and second instances of the pilot signal may be received during a DL transmission period of a subframe such as a special subframe (SSF).

The first and second instances of the pilot signal may in some cases be received by the receiver module 220 and/or the pilot signal identification module 305 described with reference to FIGS. 2, 3, and/or 4. In some cases, the instances of the pilot signal may be received under control of the channel estimation module 310, and/or the receiver module 220 and/or the pilot signal identification module 305 may be operated under control of the channel estimation module 310.

At block 1310, a first channel estimate may be calculated based at least in part on the first instance of the pilot signal, and a second channel estimate may be calculated based at least in part on the second instance of the pilot signal. In some embodiments, the channel estimates calculated at block 1310 may be calculated using the channel estimation module 310 described with reference to FIGS. 3, 4, and/or 9, and/or the combination module 405 described with reference to FIGS. 4 and/or 6.

In some cases, the first and second channel estimates may be based on a first filtered channel impulse response (CIR) and a second CIR, respectively. In other cases, the first and second channel estimates may be based on a first unfiltered CIR and a second unfiltered CIR, respectively.

At block 1315, one or more data symbols may be received following receipt of the second instance of the pilot signal. The data symbols may in some cases be received by the receiver module 220 and/or the demodulator 315 described with reference to FIGS. 2, 3, and/or 4. In some cases, the one or more data symbols may be received under control of the channel estimation module 310, and/or the receiver module 220.

At block 1320, a Doppler frequency of a channel over which the instances of the pilot signal are received may be identified. An SNR of the channel may also be identified. In some embodiments, the operations at block 1320 may be performed by the channel estimation module 310 described with reference to FIGS. 3, 4, and/or 9, and/or the extrapolation module 410 described with reference to FIGS. 4 and/or 6, and/or the Doppler frequency identification sub-module 510-a and signal to noise ratio identification sub-module 515-a described with reference to FIG. 6.

At blocks 1325 and 1330, a third channel estimate may be extrapolated from the first and second channel estimates, and as function of the Doppler frequency and SNR. The third channel estimate may correspond to a virtualized instance of the pilot signal following the second instance of the pilot signal. In some cases, a timing of the virtualized pilot signal may be selected to be during a blank period following the second instance of the pilot signal. In some cases, the blank period may be a UL transmission period of a subframe such as a SSF. The UL transmission period may sometimes be part of the same SSF in which the first and second instances of the pilot signal are received, and may follow a DL transmission period of the SSF.

In some cases, the extrapolation coefficient may be increased as the Doppler frequency increases, and decreased as the Doppler frequency decreases. In some cases, the extrapolation coefficient may be increased as the SNR increases, and decreased as the SNR decreases.

At block 1325, an extrapolation coefficient may be calculated. In some embodiments, the extrapolation coefficient may be calculated by the channel estimation module 310 described with reference to FIGS. 3, 4, and/or 9, and/or the extrapolation module 410 described with reference to FIGS. 4 and/or 6, and/or the extrapolation coefficient calculation sub-module 605 described with reference to FIG. 6.

At block 1330, the extrapolation coefficient calculated at block 1325 may be applied to a linear combination of the first and second channel estimates, to thereby extrapolate the third channel estimate. In some embodiments, the extrapolation coefficient may be calculated by the channel estimation module 310 described with reference to FIGS. 3, 4, and/or 9, and/or the extrapolation module 410 described with reference to FIGS. 4 and/or 6, and/or the channel estimate extrapolation sub-module 610 described with reference to FIG. 6.

At block 1335, the one or more data symbols received after the second instance of the pilot signal may be interpolated based at least upon the second channel estimate and the extrapolated third channel estimate. In some embodiments, the interpolation may be performed by the demodulator 315 described with reference to FIGS. 3 and/or 4.

Therefore, the method 1300 may be used for estimating a channel in which one or more data symbols follow a last instance of a pilot signal in a particular transmission. It should be noted that the method 1300 is just one implementation and that the operations of the method 1300 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Techniques described herein may be used for various wireless communication systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS. LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. At the Physical layer, the transport channels may be mapped to Physical channels.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

A computer program product or computer-readable medium both include a computer-readable storage medium and communication medium, including any mediums that facilitates transfer of a computer program from one place to another. A storage medium may be any medium that can be accessed by a general purpose or special purpose computer. By way of example, and not limitation, computer-readable medium can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for estimating a channel with discontinuous instances of a pilot signal, comprising:
receiving at least one instance of a pilot signal during a first time period;
receiving at least one instance of the pilot signal during a second time period that is subsequent to the first time period, the second time period being separated from the first time period by a blank period, wherein instances of the pilot signal are not received during the blank period;
combining a first instance of the pilot signal received during the second time period with an instance of the pilot signal received during the first time period; and
calculating a channel estimate based at least in part on the combination.

2. The method of claim 1, wherein calculating the channel estimate comprises:
calculating a coefficient corresponding to the first instance of the pilot signal received during the second time period.

3. The method of claim 2, further comprising:
identifying a Doppler frequency of a channel over which the instances of the pilot signal are received;
identifying a signal to noise ratio (SNR) of the channel; and
identifying a length of the blank period, the length being identified based at least in part on a number of unreceived instances of the pilot signal during the blank period.

4. The method of claim 3, wherein the coefficient is an infinite impulse response (IIR) coefficient and is a function of at least the Doppler frequency, the SNR, and the length of the blank period.

5. The method of claim 1, further comprising:
combining a second instance of the pilot signal received during the second time period with the first instance of the pilot signal received during the second time period.

6. The method of claim 5, further comprising:
calculating a coefficient corresponding to the second instance of the pilot signal received during the second time period, the coefficient being less than a coefficient corresponding to the first instance of the pilot signal received during the second time period.

7. The method of claim 1, further comprising:
calculating an infinite impulse response (IIR) coefficient corresponding to each instance of the pilot signal received during the second time period; and
calculating a channel estimate based at least in part on each IIR coefficient.

8. The method of claim 1, wherein the blank period is caused by at least one of a time-division duplex (TDD) scheme, a discontinuous reception (DRX) scheme, a Multimedia Broadcast Single-Frequency Network (MBSFN) signal reception, and a measurement gap.

9. An apparatus for estimating a channel with discontinuous instances of a pilot signal, comprising:
a processor;
memory in electronic communication with the processor; and
instructions stored in the memory, the instructions being executable by the processor to:
receive at least one instance of a pilot signal during a first time period;
receive at least one instance of the pilot signal during a second time period that is subsequent to the first time period, the second time period being separated from the first time period by a blank period, wherein instances of the pilot signal are not received during the blank period;
combine a first instance of the pilot signal received during the second time period with an instance of the pilot signal received during the first time period; and
calculate a channel estimate based at least in part on the combination.

10. The apparatus of claim 9, wherein the instructions are further executable by the processor to:
calculate the channel estimate by calculating a coefficient corresponding to the first instance of the pilot signal received during the second time period.

11. The apparatus of claim 10, wherein the instructions are further executable by the processor to:
identify a Doppler frequency of a channel over which the instances of the pilot signal are received;
identify a signal to noise ratio (SNR) of the channel; and
identify a length of the blank period, the length being identified based at least in part on a number of unreceived instances of the pilot signal during the blank period.

12. The apparatus of claim 11, wherein the coefficient is an infinite impulse response (IIR) coefficient and is a function of at least the Doppler frequency, the SNR, and the length of the blank period.

13. The apparatus of claim 9, wherein the instructions are further executable by the processor to:
combine a second instance of the pilot signal received during the second time period with the first instance of the pilot signal received during the second time period.

14. The apparatus of claim 13, wherein the instructions are further executable by the processor to:
calculate a coefficient corresponding to the second instance of the pilot signal received during the second time period, the coefficient being less than a coefficient corresponding to the first instance of the pilot signal received during the second time period.

15. The apparatus of claim 9, wherein the instructions are further executable by the processor to:
calculate an infinite impulse response (IIR) coefficient corresponding to each instance of the pilot signal received during the second time period; and
calculating a channel estimate based at least in part on each IIR coefficient.

16. The apparatus of claim 9, wherein the blank period is caused by at least one of a time-division duplex (TDD) scheme, a discontinuous reception (DRX) scheme, a Multimedia Broadcast Single-Frequency Network (MBSFN) signal reception, and a measurement gap.

17. A method for estimating a channel in which one or more data symbols follow a last instance of a pilot signal in a particular transmission, comprising:
receiving at least a first instance of a pilot signal and a second instance of a pilot signal, the second instance of the pilot signal being the last instance of the pilot signal in the particular transmission, and the first instance of the pilot signal temporally preceding the second instance of the pilot signal;
calculating a first channel estimate based at least in part on the first instance of the pilot signal and calculating a second channel estimate based at least in part on the second instance of the pilot signal;
receiving one or more data symbols following the receipt of the second instance of the pilot signal;
extrapolating a third channel estimate from the first and second channel estimates, the third channel estimate corresponding to a virtualized instance of the pilot signal following the second instance of the pilot signal; and
interpolating the one or more data symbols based at least upon the second channel estimate and the extrapolated third channel estimate.

18. The method of claim 17, wherein the first and second channel estimates are based on a first filtered channel impulse response (CIR) and a second filtered CIR, respectively.

19. The method of claim 17, wherein the first and second channel estimates are based on a first unfiltered channel impulse response (CIR) and a second unfiltered CIR, respectively.

20. The method of claim 17, wherein:
the first instance of the pilot signal and the second instance of the pilot signal are received during one of a downlink (DL) transmission period of a subframe or during a special subframe (SSF); and
a timing of the virtualized instance of the pilot signal is selected to be during at least one of a blank period following the second instance of the pilot signal or a blank period of the SSF.

21. The method of claim 17, wherein extrapolating the third channel estimate comprises:
calculating an extrapolation coefficient; and
applying the extrapolation coefficient to a linear combination of the first and second channel estimates.

22. The method of claim 21, wherein the extrapolation coefficient is a function of at least a Doppler frequency of the channel and a signal to noise ratio (SNR) of the channel, the method further comprising:
increasing the extrapolation coefficient as the Doppler frequency increases; and
decreasing the extrapolation coefficient as the Doppler frequency decreases.

23. The method of claim 21, further comprising:
decreasing the extrapolation coefficient as the SNR decreases; and
increasing the extrapolation coefficient as the SNR increases.

24. An apparatus for estimating a channel in which one or more data symbols follow a last instance of a pilot signal in a particular transmission, comprising:
a processor;
memory in electronic communication with the processor; and
instructions stored in the memory, the instructions being executable by the processor to:
receive at least a first instance of a pilot signal and a second instance of a pilot signal, the second instance of the pilot signal being the last instance of the pilot signal in the particular transmission, and the first instance of the pilot signal temporally preceding the second instance of the pilot signal;
calculate a first channel estimate based at least in part on the first instance of the pilot signal and calculate a second channel estimate based at least in part on the second instance of the pilot signal;
receive one or more data symbols following the receipt of the second instance of the pilot signal;
extrapolate a third channel estimate from the first and second channel estimates, the third channel estimate corresponding to a virtualized instance of the pilot signal following the second instance of the pilot signal; and
interpolate the one or more data symbols based at least upon the second channel estimate and the extrapolated third channel estimate.

25. The apparatus of claim 24, wherein the first and second channel estimates are based on a first filtered channel impulse response ( ) and a second filtered CIR, respectively.

26. The apparatus of claim 24, wherein the first and second channel estimates are based on a first unfiltered channel impulse response (CIR) and a second unfiltered CIR, respectively.

27. The apparatus of claim 24, wherein the instructions are further executable by the processor to:
receive the first instance of the pilot signal and the second instance of the pilot signal during one of a downlink (DL) transmission period of a subframe and a special subframe (SSF); and
select a timing of the virtualized instance of the pilot signal to be during one of a blank period following the second instance of the pilot signal and a blank period of the special subframe.

28. The apparatus of claim 24, wherein the instructions are further executable by the processor to extrapolate the third channel estimate by:
calculating an extrapolation coefficient; and
applying the extrapolation coefficient to a linear combination of the first and second channel estimates.

29. The apparatus of claim 28, wherein the extrapolation coefficient is a function of at least a Doppler frequency of the channel and a signal to noise ratio (SNR) of the channel, wherein the instructions are further executable by the processor to:
increase the extrapolation coefficient as the Doppler frequency increases; and
decrease the extrapolation coefficient as the Doppler frequency decreases.

30. The apparatus of claim 29, wherein the instructions are further executable by the processor to:
decrease the extrapolation coefficient as the SNR decreases; and
increase the extrapolation coefficient as the SNR increases.
